(19) United States
(12) Patent Application Publication
(10) Pub. No.: US 2005/0285431 A1
(43) Pub. Date: Dec. 29, 2005

(54) Device for protecting individuals during a frontal impact with a motor vehicle

(76) Inventors: Martin Rex, Windeck (DE); Frank Mika, Numbrecht (DE); Raphael Hartebrodt, Drolshagen (DE); Jozsef Lang, Budapest (HU)

Correspondence Address: Daniel J Hudak Jr;Hudak Shunk & Farine Company, Suite 307, 2020 Front Street, Cuyahoga Falls, OH, 44221, US

(21) Appl. No.: 10/527,573

(22) PCT Filed: Sep. 16, 2003
(86) PCT No.: PCT/EP03/10268

§ 371 Date: Mar. 14, 2005

(30) Foreign Application Priority Data
Sep. 19, 2002 (DE) 10243497.2

(51) Int. Cl. B62D 25/10

(52) U.S. Cl. 296/187.04; 296/193.11

(57) ABSTRACT

This protective device (100) is used in a motor vehicle having a front hood (300), which covers the front of the vehicle, leads up to the front windshield and which, at the windshield, is rotatably coupled via a hinge system (200) to the body of the front of the vehicle on both sides of the vehicle. According to the state of the art, the inventive protective device consists of a hinge support (2), which is provided for indirectly coupling the hinge system (200) to the vehicle body and which is mounted in a raisable manner on the body of the front of the vehicle. The protective device also consists of an energy-storing implement, which acts upon the hinge support (2) while being provided in the form of a spring storage system (4), and consists of a sensor-controlled retaining device (11) for actively engaging with the hinge support (2) so that, in the normal state, the hinge support is held down and during a collision, can be released by sensor actuation in order to execute a limited raising movement. The aim of the invention is to prevent, in particular, diversions of force when the protective device is raised. To this end, the inventive device is designed in such a manner that a guide base plate (8), which is linearly guided in both directions inside a housing (1), is provided in the form of a raising plate for the hinge support (2). The hinge support (2) is eccentrically coupled to this guide base plate in a tilting manner by means of a shaft (3) and is actively engaged with the spring storage system (4) and with the sensor-actuated retaining device (11).

The invention pertains to a device according to the preamble of claim 1.

Each year many accidents occur in which pedestrians, whether they be children or adults, or cyclists, are hit by a motor vehicle, thrown against the front or engine hood and against the windshield, and usually experience severe injuries. The head and the upper body of an adult pedestrian or cyclist is especially in danger in this case, since it has been shown by crash tests as well as experience that this part of the body during a collision with a motor vehicle hits the front hood in the rear and relatively hard region at the transition to the windshield and is therefore considerably injured.

Given these requirements, the motor vehicle industry has been working intensively on the problem of improving the protection of people.

A number of possibilities are known for solving this problem.

Thus, DE 27 37 876 A shows a foil or net-like catcher element, which can be triggered under sensor control, and which spans the width of the vehicle in the front hood region lying in front of the windshield. This solution disadvantageously changes the typical appearance of an engine hood in the transitional region to the windshield.

DE 27 11 338 A shows a similar design, in which an air bag inflatable under sensor control lies in the transitional region between windshield and front hood in event of an impact.

This solution as well requires a relatively costly structure, altering the usual basic layout in the so-called transitional zone.

DE27 11 339 A shows solution in which the front hood is mounted so that it can move lengthwise in event of a collision, thereby producing deformation zones. These solutions likewise produce a deviation from the usual mounting of the front hood via the front lock and the rear hinges. Moreover, the danger exists of the front hood penetrating the windshield in event of a collision with a large obstacle.

DE 28 14 107 A in conjunction with DE 28 41 315 shows a basic solution for reducing the risk of injury during the impact of pedestrians and cyclists against the front hood, based on the notion of rendering quite safe the relatively hard and nonflexible impact zone situated in the rear area of the front hood. This is accomplished by a device activated by means of an impact sensor to move the front hood from a position of rest into a raised and flexible impact position, i.e., by a so-called “active front hood.” Thanks to the fact that the front hood during the collision with a pedestrian that is detected by the impact sensor is moved flexibly into an impact position, which is raised relative to its resting, or normal position, a deformation pathway of the vehicle body is created that produces a more favorable dissipation of the energy during the impact of the pedestrian's chest or head, ensuring decreased head and chest decelerations and, thus, less risk of injury.

In the case of the aforementioned DE 28 14 107 A, the front hood is raised by at least one gas bag which can inflate during a collision. The design shown, however, can only be employed for motor vehicles whose front hood can swivel about an axis lying at the upper front edge of the front body.

However, the known design cannot be used for motor vehicles in which the front hood is hinged to the front body at the windshield side. Moreover, in the known instance there exists the major danger that the front hood will penetrate into the windshield during a rather strong impact of the vehicle against an obstacle. Again, the front hood exhibits a strong elastic hysteresis upon impact, which in turn increases the danger of injury.

The same holds for the aforementioned DE 28 41 315 A, which shows a corresponding safety mechanism, in which the gas bag is replaced by a piston and cylinder unit, which can be operated pyrotechnically or hydraulically or pneumatically. The return movement of the piston during an impact can be controlled by a force limiting device in this case.

DE 201 06 478U1 shows a design working by the aforementioned basic solution of a front hood which can be flexibly raised up in event of a collision, but a front hood attached by hinges to the windshield end. It envisions a pretensioned spring force accumulator, which is released, or triggered by an electric motor in event of a collision, and it can also be placed back under tension, or reversed, by electric motor. This design, which proposes to avoid a pyrotechnical propulsion, has, however, a relatively long triggering time.

DE 197 12 961 A1 and DE 101 11 096 A1 (=EP 1 238 893A1), finally, also show an impact protection by a front hood which can be flexibly raised in a collision, being attached by a hinge arrangement at the windshield end. This hinge arrangement is secured via a swiveling or movably mounted hinge beam to the chassis of the front body so that in the event of a collision of the vehicle with a person, the front hood can be swiveled or moved upward, i.e., raised, by means of an energy-storing mechanism engaging with the hinge beam, such as a spring force accumulator.

This known design is based on the notion of raising the hinge arrangement itself with the attached hinge beam, so that it is not necessary to provide for a complex uncoupling mechanism between hinge arrangement and front hood in event of an impact. Moreover, the forced guidance via the hinged or movable hinge beam accomplishes a secure fixation of the front hood, which reliably prevents the front hood from penetrating into the windshield during a rather strong impact of the vehicle against an obstacle.

The invention starts with this basic design principle.

In the known case, three embodiments are represented.

In the first embodiment, the hinge beam, which more or less forms the base plate for the hinge arrangement, is linked at its front end segment to the strut for the front fender by a pivot axis on a screw-down plate. At its rear end segment, the hinge beam is locked via a sensor-controlled locking mechanism with an eccentrically mounted locking bar. At a predetermined distance from the pivot axis, an energy accumulating mechanism such as a pretensioned helical spring, or a piston/cylinder unit, is linked to the hinge beam. In event of a collision, the locking mechanism is released and the hinge beam becomes free.

This quickly swivels upward thanks to the pretensioned helical sprint and lifts the front hood along with the hinge arrangement by a predetermined angle. Besides the embodiment with the swiveling hinge beam, which is also the subject of DE 101 08 880 A, two embodiments are also presented in which the hinge beam during a collision is moved upward by a limited path using link guideways, without a rotary bearing. In one embodiment, the hinge beam sits on two curved guide arms. In the other embodiment, a tilted piston/cylinder unit is provided, being joined to the hinge beam via a force-deflecting intermediate element.

The known embodiments have the following drawbacks.

In both the case of the raising with one guide arm and the case with two guide arms, force deflections are necessary for the raising. Besides friction losses, this causes losses of force due to decomposition of components, which is a serious detriment when using spring accumulators for the lifting, since these need to be correspondingly larger in dimension and therefore require considerable space, which is not always available in the place where the lifting device needs to be arranged.

Moreover, in the case of the guide with two arms, a curved trajectory is needed, which besides the described drawback also requires a curved trajectory for the spring of the spring accumulator, which can only be accomplished in very costly manner, in order that the hinge beam is also reliably raised up. Finally, the known device offers no design opportunity for a deformable locking or a reversing of the raised front hood.

The invention is based on the problem of configuring the above described device for protection of persons in event of a frontal impact against a motor vehicle in such a way that no force deflection is necessary when raising the front hood by a spring accumulator and it offers design opportunities for a deformable locking and a reversing of the raised front hood.

The solution is accomplished in a device for the protection of persons during a frontal impact against a motor vehicle, having a front hood which covers the front body and extends as far as the front windshield, being linked to the chassis of the front body by a hinge arrangement at either side of the vehicle at the windshield end, consisting of a hinge beam for the indirect linking of the hinge arrangement at the chassis side, which is arranged on the chassis of the front body so that it can be raised, and an energy-accumulating mechanism engaging with the hinge beam, in the form of a spring accumulator arrangement, as well as a sensor-controlled holding device for an active engagement with the hinge beam, so that in the normal condition the hinge beam is held down, and in event of a collision it can be released under sensor activation for a limited raising motion, in that the invention provides for a guiding base plate with double linear guiding in a housing as a mounting plate for the hinge beam, to which the hinge beam is eccentrically linked by a shaft in seesaw fashion, and which actively engages with the spring accumulator arrangement and the sensor-activated holding device.

Since the springs of the two spring accumulators rise up in a linear path when triggered and thereby push up the double-guided mounting plate in linear path, no force deflection is required, which has a beneficial influence on the dimensioning of the springs of the spring accumulators and also advantageously reduces the expense of the design in terms of the guidance of the springs and the lifting of the mounting plate.

Thanks to the seesaw linking of the hinge beam, the corresponding X-displacement of the front hood during the lifting is balanced out in simple manner, without blocking the system.

No curved lifting paths are required. The seesawing also enables an adaptation of every make and model of hinge.

Moreover, the invented design offers advantageous opportunities for the installation of a mechanism for locking the system in the lifted condition, as well as for reversing the lifted front hood after an accidental triggering.

Configurations of the invention, especially in terms of the aforesaid mechanism for locking and reversing, are characterized in the subsidiary claims and furthermore appear in the description of the drawings.

The invention will be described more closely by means of a sample embodiment, shown in the drawings in various views.

These show:

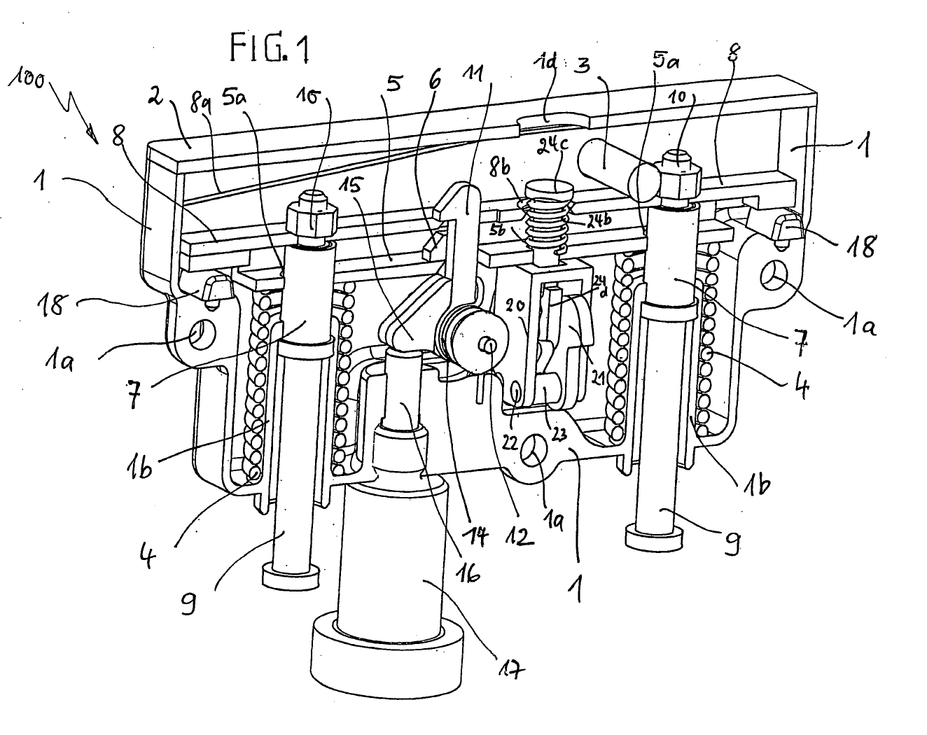

FIG. 1 in a schematic isometric representation with the front housing wall removed from the invented device for raising the front hood of a passenger car, attached at the windshield end, by two spring accumulators after triggering by a pyrotechnical actuator, in the resting state, i.e., with pretensioned springs, including the mechanism for locking the raised front hood and for reversing after a triggering without collision,

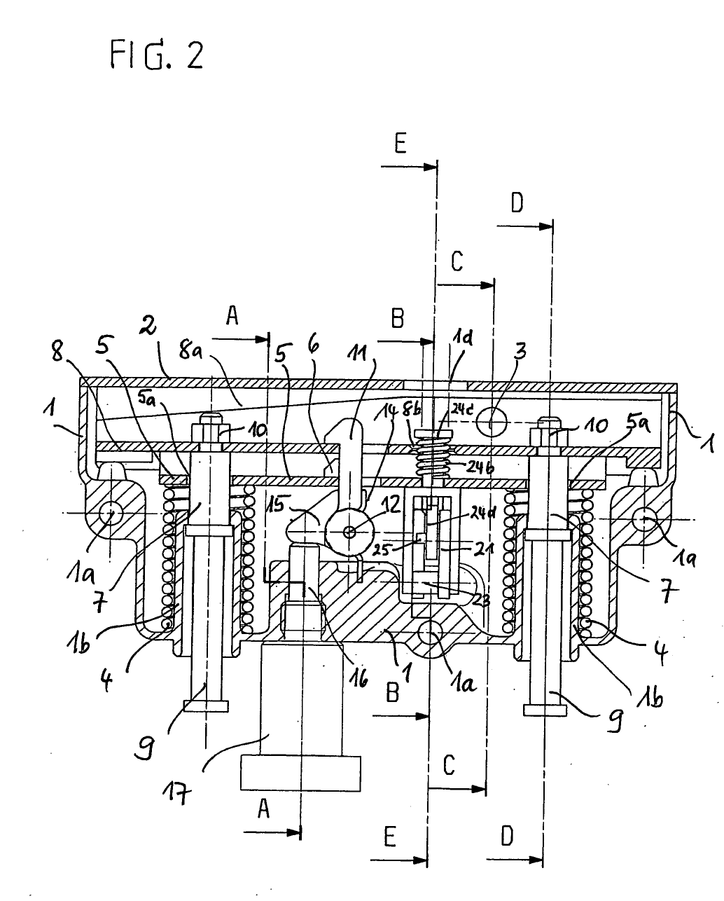

FIG. 2, a lengthwise section through the device of FIG. 2,

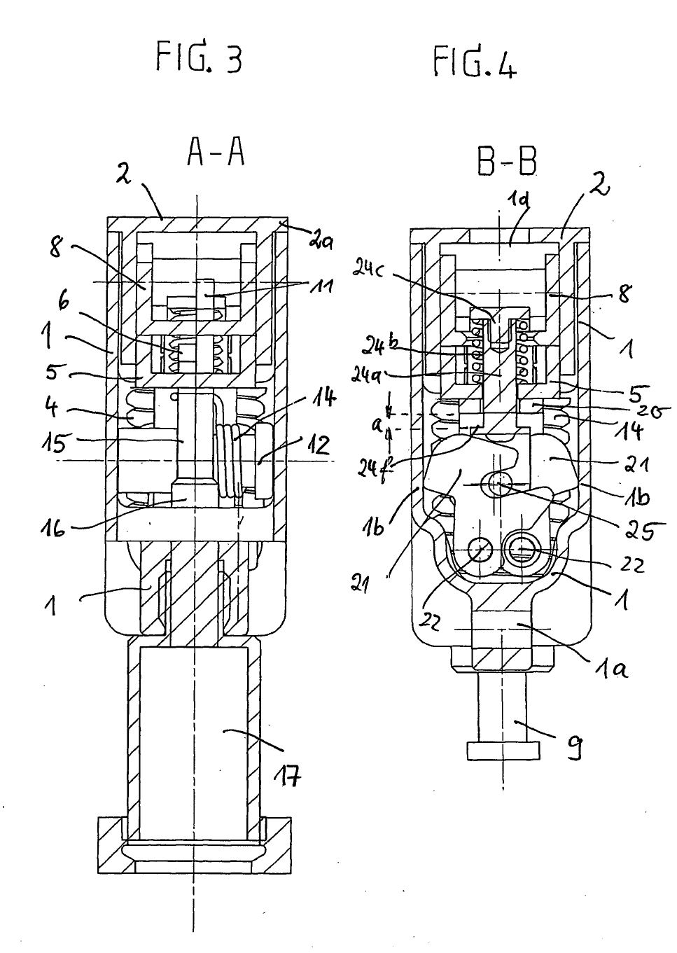

FIG. 3, a cross sectional view along line A-A in FIG. 2,

FIG. 4, a cross sectional view along line B-B in FIG. 2,

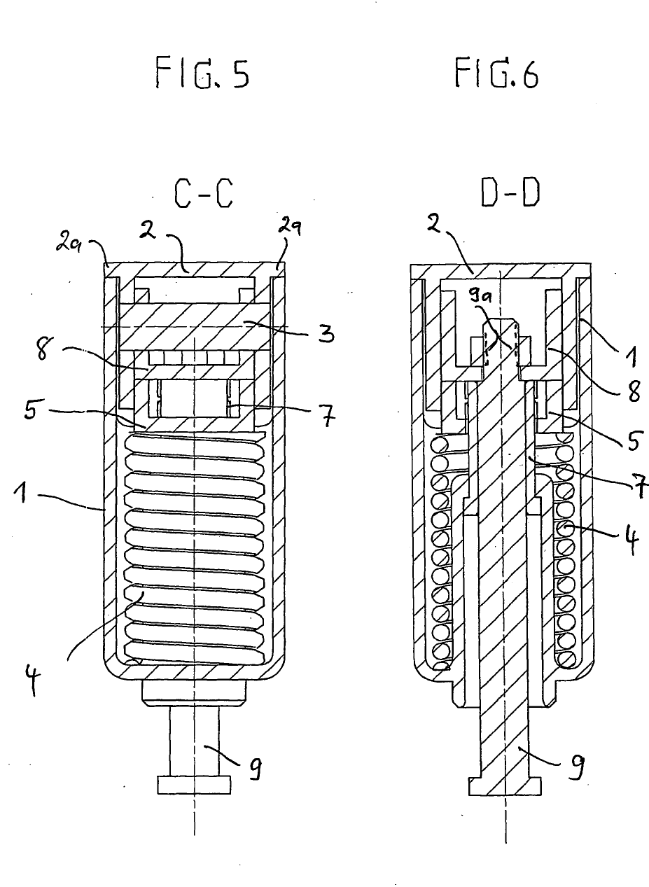

FIG. 5, a cross sectional view along line C-C in FIG. 2,

FIG. 6, a cross sectional view along line D-D in FIG. 2,

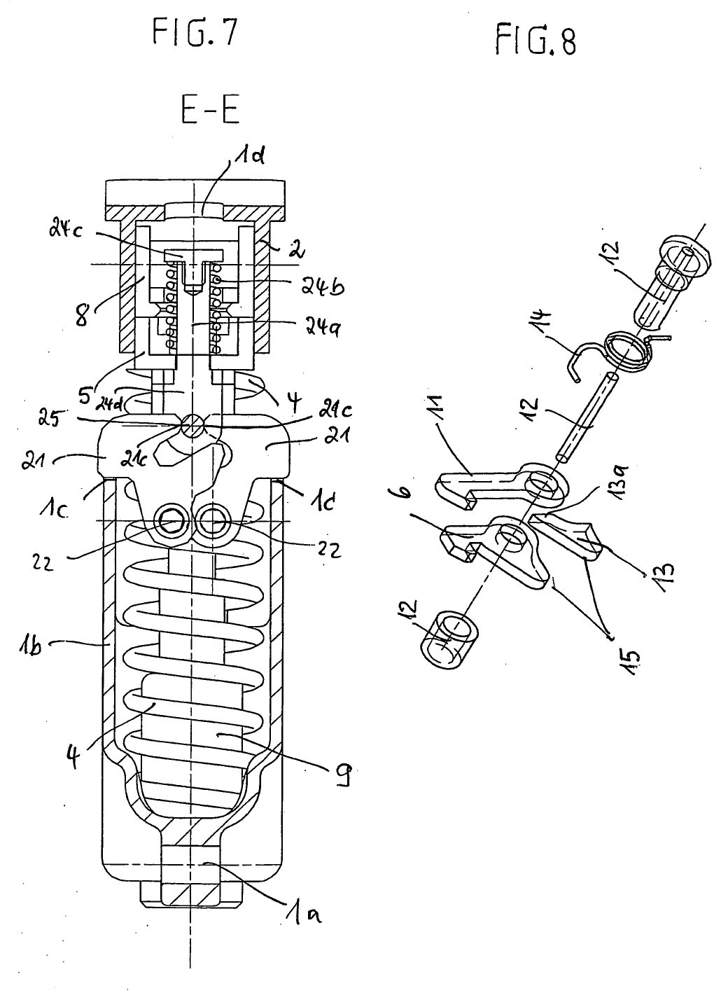

FIG. 7, a cross sectional view along line E-E in FIG. 2, corresponding to FIG. 4, but with spring accumulator triggered,

FIG. 8, in an exploded view, the detent pawls represented in FIGS. 1 and 2 for holding the system in the resting state against the pretensioning force of the springs in the spring accumulator,

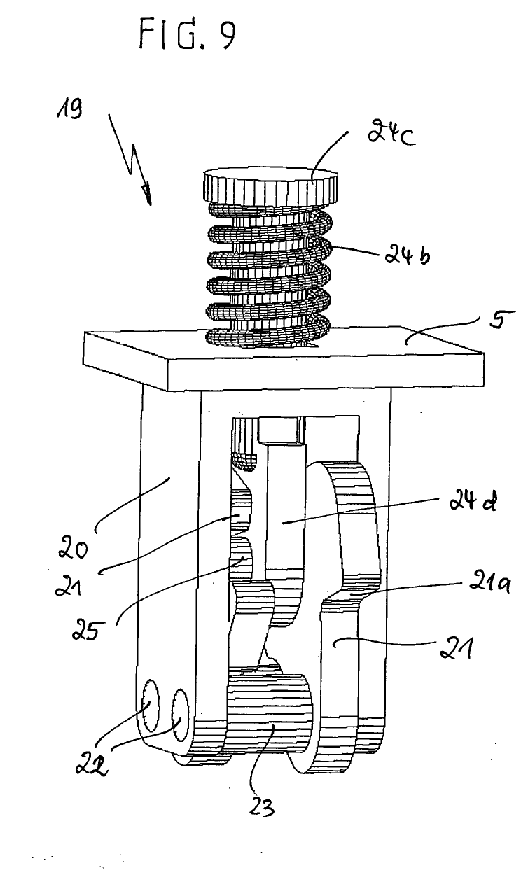

FIG. 9, in an isometric representation, a magnified feature from FIG. 1 for a more detailed representation of the locking and reversing mechanism in the resting state of the system,

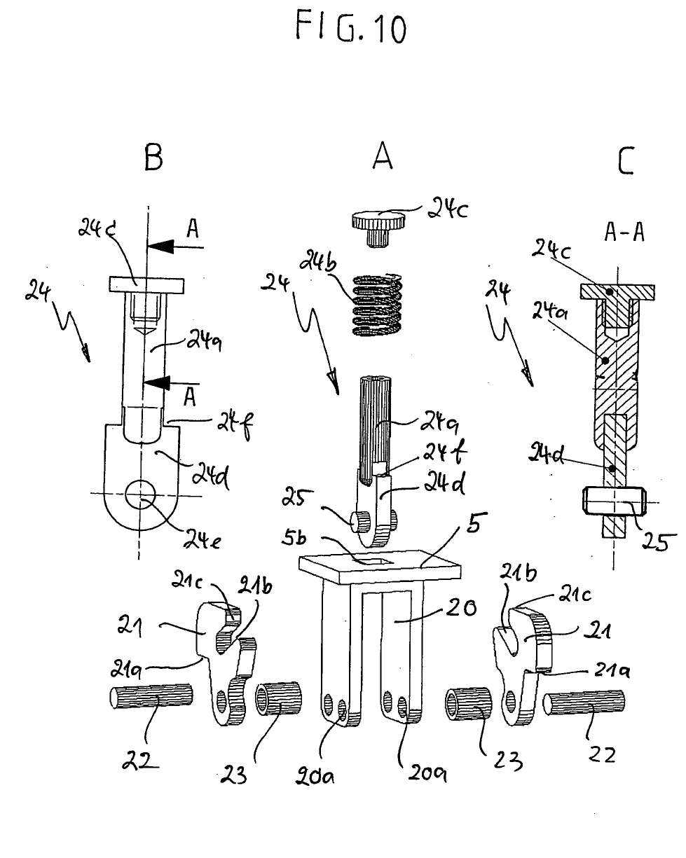

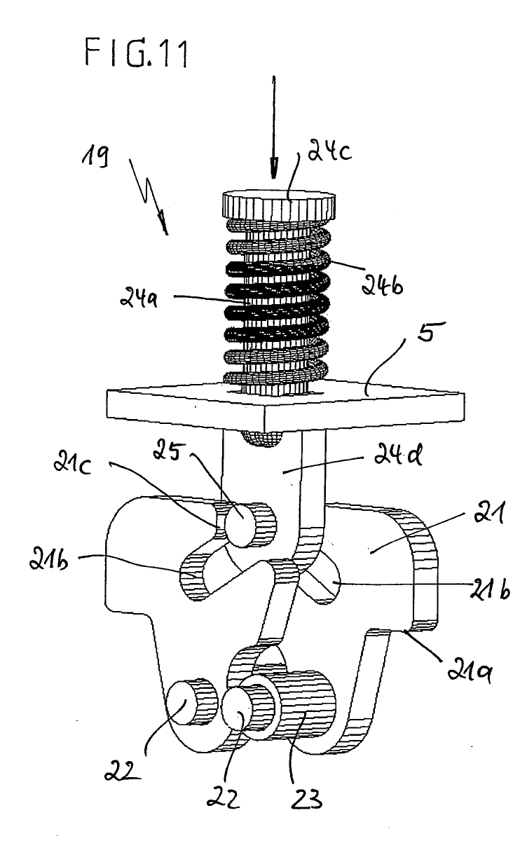

FIG. 10, in an exploded view, the components of the mechanism per FIG. 9,

FIG. 11, in an isometric representation corresponding to FIG. 9, the state of the locking and reversing mechanism in the raised, i.e., in the locked state of the system,

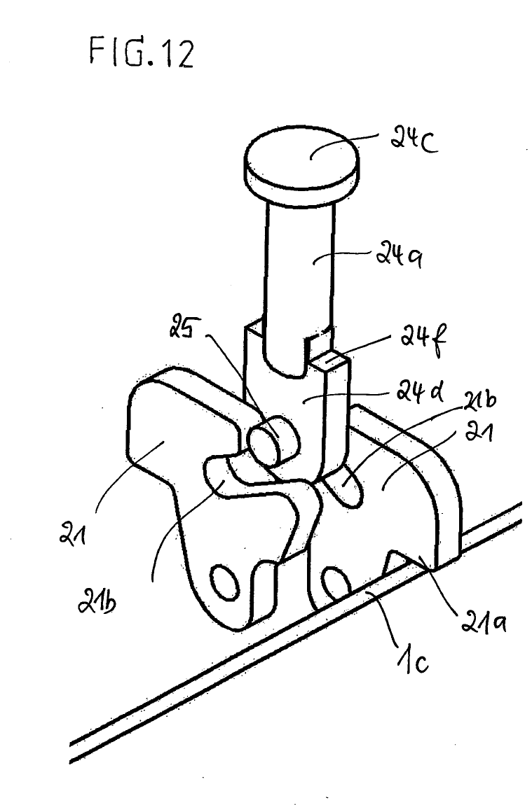

FIG. 12, the same state of the system as in FIG. 11, but in a simplified representation,

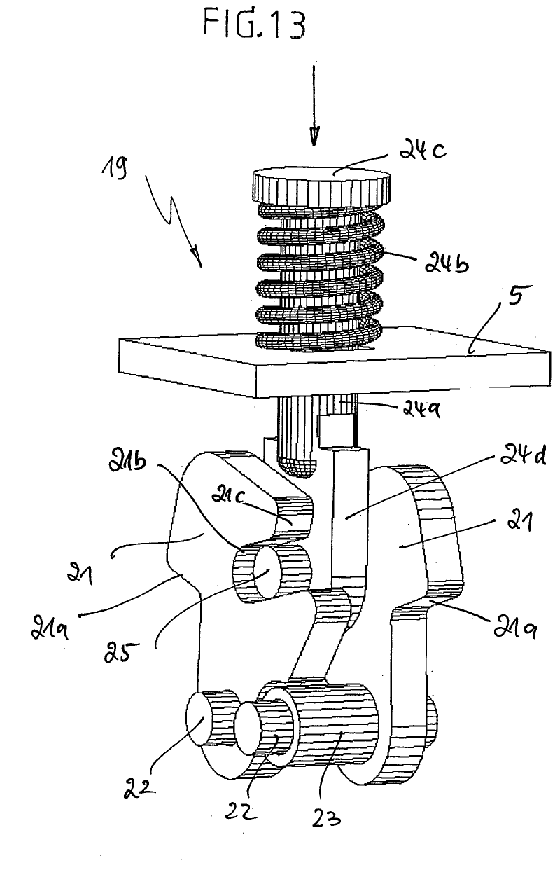

FIG. 13, in an isometric representation corresponding to FIGS. 9 and 11, the state of the locking and reversing mechanism when reversing the system from the raised state to the resting state,

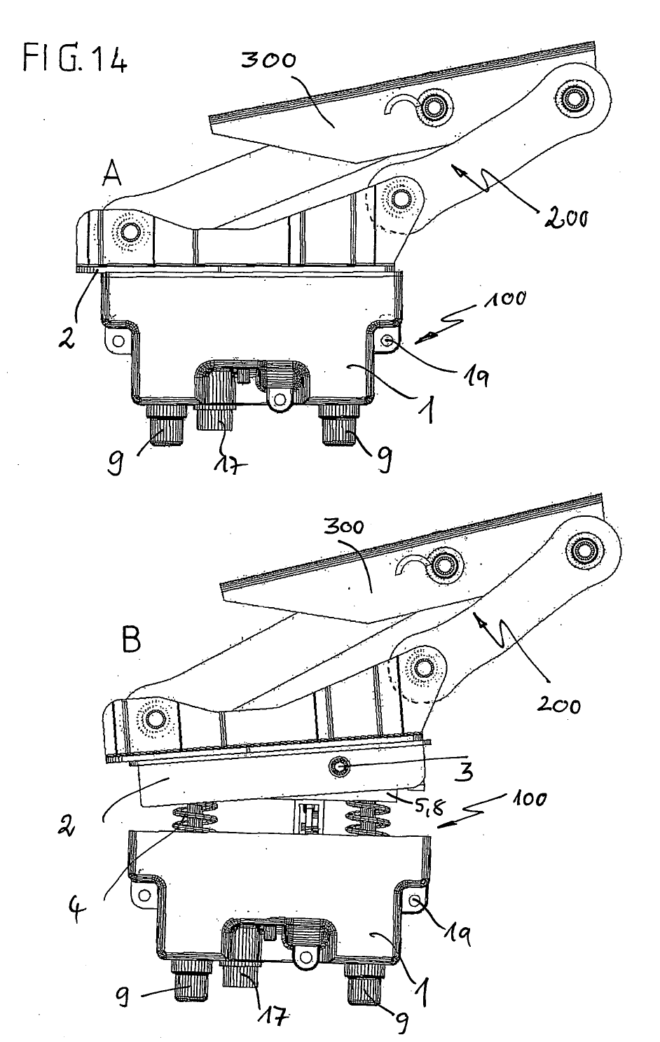

FIG. 14, in two partial drawings A and B, in a schematic overall representation, the connection of the front hood of the car via the hinge arrangement to the device per FIG. 1, namely, in part A, in the resting state of the system, and in part B, in the raised state of the system, and

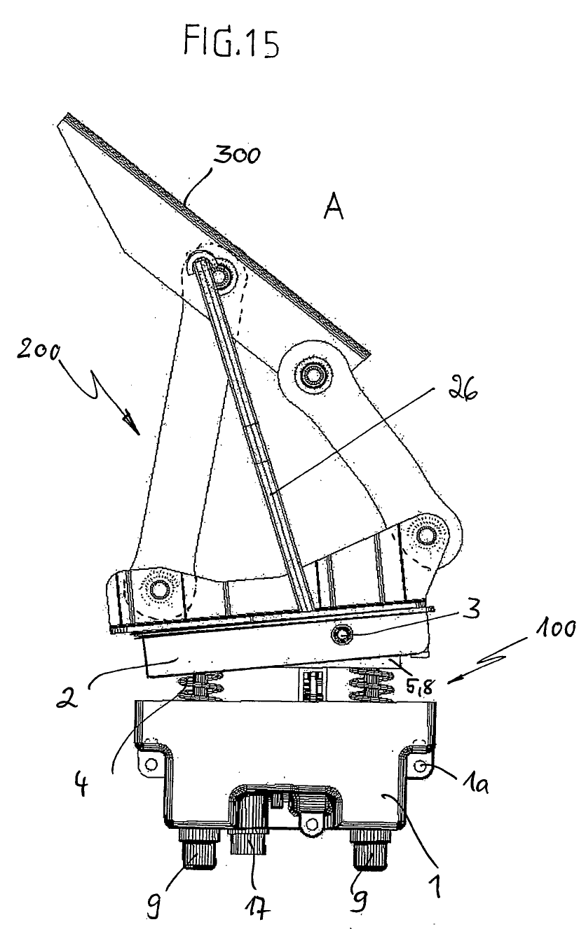

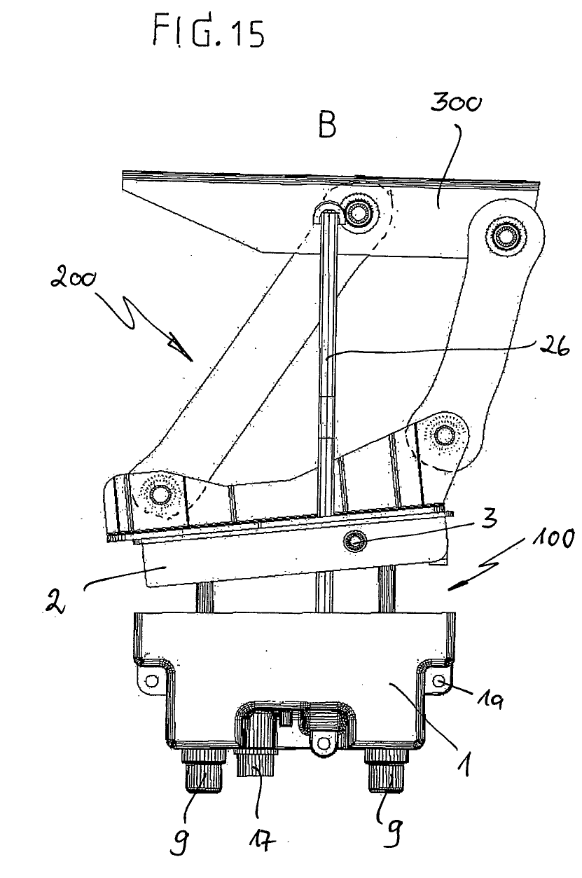

FIG. 15, in two parts A and B, the reversing of the raised system by using reversing rods and the front hood actuation.

The invented device 110, represented in the drawings, for protecting individuals during a frontal impact with a motor vehicle, is based on the principle of raising the front hood of the motor vehicle, attached at the windshield end, along with its hinge arrangement in the attachment region, by a predetermined length relative to the chassis of the front body in event of a collision with the individual.

The device 100 has, first, a housing 1, which contains the sensor-controlled components for raising the front hood, being screwed via three boreholes la to the chassis of the front body in the region of the hinge arrangements, preferably to the strut of the fender. One such device is arranged on either side of the front body.

The hinge arrangement 200, not shown in FIGS. 1 and 2, but recognizable from FIGS. 14 and 15, and possessing two articulated arms in the example, is in familiar fashion secured first to the front hood 300 and secondly to a hinge beam 2 of the invented device 100. This hinge beam 2, as is shown in particular by FIG. 3, is configured as a U-profile, and in the resting state it lies by its lateral projections 2a against the upper end edge 1c of the housing 1, closing it off tightly.

This U-profile is linked to a bolt 3 so that it can rotate off-center against the direction of travel. Thus, the hinge beam 2 is configured as a kind of seesaw, i.e., it can tilt in the direction of travel in order to offset the movement in the horizontal, i.e., X direction when deployed.

For the raising of this hinge beam in event of a collision, there are two compression springs 4 provided as spring accumulators, being arranged at a spacing in the housing 1 around corresponding guide bodies 1b of the housing 1, whose lower ends are each thrust against a housing floor, and at the top they are in active engagement with a pretensioning plate 5.

With this pretensioning plate 5 the compression springs 4 can be pretensioned, and the pretensioning plate 5 is held down in the tensioned state of the compression springs by means of a first detent pawl 6. The pretensioning plate 5, as shown in FIG. 3, is configured as a U-profile, open at the top, having two boreholes 5a, each of which accommodates a guide sleeve 7 that is fixed relative to the housing; in this way, the pretensioning plate 5 is mounted so that it can move relative to the guide sleeves 7.

The pretensioning plate 5 is in direct active contact with a guiding base plate 8, which is likewise configured as a U-profile open on top (FIG. 3). This is screwed together with two guide pillars 9, which are movably accommodated in the respective guide sleeves 7. For this, the upper end of each roller 9 has an outer thread 9a (FIG. 6), which passes through the guiding base plate in corresponding boreholes and onto each of which a nut 10 is screwed above the guiding base plate. Thus, the guiding base plate 8 is mounted so that it can move together with the guide pillars 9 in the guide sleeves 7.

In order to hold the guiding bases plate 8 in the position of rest, i.e., in the position of the pretensioned springs, there is a second detent pawl 11 provided. Two elastomeric bearings 18 at the ends provide for the necessary pretensioning of the guiding base plate against the detent pawl 11.

The guiding base plate, moreover, has at each leg an aligned opening for the axially secured accommodation of the bolt 3, around which the seesaw hinge beam 2 can pivot. The U-profile of the guiding base plate, i.e., the side legs of the profile, are sloping in the direction of travel (bevel 8a inn FIGS. 1 and 2), so that when the hinge beam is in the raised state there is room available for a swivel movement of the seesaw in counterclockwise direction. The U-profile of the guiding base plate 8, open at the top, is received in the U-profile of the seesaw hinge beam 2, which is open at the bottom.

Both detent pawls 6, 11 are pivoted about a pawl bolt 12, fixed to the housing. The detent pawl 6, as is also shown by FIG. 8, has a stop piece 13, which is preferably welded together with the detent pawl 6, and a stop 13a to entrain the detent pawl 11. If the first detent pawl 6 is swiveled, the second detent pawl 11 is carried along by the stop 13a. Both detent pawls 6, 11 are pretensioned by a leg spring 14 in the locking, i.e., the holding direction. The first detent pawl 6 has a cam 15, as does the stop piece 13a, which is in active connection with a trigger pin 16 of a pyrotechnical actuator 17, arranged firm on the housing.

FIGS. 1 and 2 show, as already mentioned, the resting state of the system. FIG. 14, part A, shows in overall view the position of the front hood 300 of the car and the hinge arrangement 200 in the resting state of the invented raising device 100. The hinge beam 2 sits tightly on the housing 1 here.

Now, if the pyrotechnical actuator 17 is activated, especially under sensor control during a collision with a pedestrian, the pin 16 of the actuator is pushed out, as FIG. 1 shows in particular, and swivels both detent pawls 6, 11 clockwise. In this way, both the pretensioning plate 5 and the guiding base plate 8 are released, so that the helical springs 4 of the spring accumulator very quickly push up, i.e., raise the pretensioning plate 5 and, through the direct contact with the guiding base plate 8, this as well. The seesaw hinge beam 2 is also raised with the hinge arrangement 200, which can tilt accordingly in the direction of travel in order to cancel the X-movement of the front hood, resulting from the linear raising, thanks to the bevel 8a of the guiding base plate 8.

As a result of this raising motion, the front hood 300 is lifted by a predetermined amount, such as 55 mm, in the region of the windshield (FIG. 14, part B).

So that the front hood 200 cannot swing back during a collision, a mechanism 19 is provided for locking the hinge beam 2 in the raised position and for reversing the raised hinge beam after a triggering not connected with a collision. Such a mechanism is not provided in the known designs, and therefore it represents a major component of the invented device 100. However, it can also be provided in other raising designs with spring accumulators.

This mechanism 19 is described in detail hereafter by means of FIGS. 1., 2, 4, 7 and 9 to 15 on account of its significance. First of all, it has a U-shaped holder 20, which is firmly connected to the pretensioning plate 5, e.g., it is welded to it. This U-shaped holder therefore moves upward along with the pretensioning plate 5 as it is lifted after being triggered and moves downward with it when reversing the system.

In the U-shaped holder 20, two detent pawls 21 are pivoted opposite to each other by means of cylindrical pins 22 and spacing sleeves 23 in corresponding boreholes 20a. The detent pawls 21 each have a stopping edge 21a for an active engagement with the upper end edge 1c of the housing in the deployed state, as well as a slotted link 21b for the guidance of a bolt, which shall be described afterwards.

The mechanism 19, moreover, has a plunger 24 which, as is shown in particular by FIG. 10, consists of an upper cylindrical segment 24a, which is encased in a helical spring 24b, and into which a head piece 24c is screwed, as well as a lower flat piece 24d, rounded off at the base, with a borehole 24e. In the borehole 24d a bolt 25 with predetermined shear or deformation behavior is arranged in active engagement with the detent pawls 21. In the lower segment 24d, at the transition to the upper segment 24a, there is a stopping edge 24f for an abutment against the yoke of the U-shaped holder 20 after overcoming a control length a (FIG. 4).

In the assembled state of the mechanism 19, the plunger 24 protrudes from an opening 5b in the pretensioning plate 5, the helical spring 24b being placed prestressed between the head 24c and the pretensioning plate 5, and also from an opening 8b in the guiding base plate 8 (Figures and 2), while there is an aligned opening 1d above the head 24c in the seesaw hinge beam 2.

In the resting state (see in particular FIGS. 4 and 9), the bolt 25 is at the end of the slotted link guide 21b, the detent pawls 21 are retracted and lie against the side walls of the housing 1. When the pretensioning plate 5 is lifted after a triggering, the U-shaped holder 20 moves up with the detent pawls 21 and the plunger 24, and at the end of the raising movement the stopping edge 21 a of the detent pawl is at the height of the upper edge 1a of the housing 1 (FIG. 12). Thanks to the pretensioning of the spring 24b, however, the plunger 24 moves with the shear bolt 25 further upward by the control length a relative to the U-shaped holder 20, i.e., until the stopping edge 24f of the plunger abuts against the yoke of the U-shaped holder 20, so that the detent pawls 21 are swung outward by the slotted link guide 21b and their stopping edges 21 a abut against the upper end edge 1c of the housing (FIGS. 7, 11 and 12).

Since in this position the front edges 21c of the detent pawls lie with a spacing at the shear bolt 25, a forceful return movement of the detent pawl is only possible by the detent pawls shearing off or deforming the bolt 25. Thus, the shear bolt serves as a deformation element in event of a collision (dissipation of force by the work of shearing or deformation), i.e., when the end of its elastic deformation with respect to the front hood 300 is reached, the shear bolt yields under a predefined force and the seesaw hinge beam 2 or the guiding base plate 8 moving it travels back into the spring accumulator 4 with its guide pillars.

In order to reverse the device 100 after an unintentional raising of the front hood 300 with no collision, a rod-shaped tool, i.e., a reversing rod 26 (FIG. 15) is used to exert a vertical force on the head 24c of the plunger 24 through the opening 1d. This causes it to move downward, whereupon the shear bolt 25 via the slotted link guides 21b swing the detent pawls 21 back, eliminating the locking with the end edges 1c of the housing (FIG. 13), so that the U-shaped holder 20 with the detent pawls 21 retracted can then travel back into the housing 1 to the starting position as represented in FIG. 4, while tensioning the compression springs 4.

Since this requires one to activate both devices 100 assigned to the hinge arrangements 200 on either side and, furthermore, one must overcome relatively large spring forces for the compression springs, a reversing rod 26 is inserted into the opening 1d of the hinge beam 2 at each side of the opened front hood 300, as shown in FIG. 15, and the necessary reversing force is easily applied to both plungers 24 by pressing down on the hood at the front end, making use of a lever action.

The sample embodiment depicted in the drawings is a very advantageous sample embodiment. However, modifications are also conceivable, without leaving the principle of the invention. Thus, for example, instead of the direct releasing of the detent pawls by the pin 15 via the cams 15 as represented in FIG. 1, an indirect releasing is possible using a push/pull cable in the manner of a wire release in photography. In this case, the actuator 17 can be arranged at an easily accessible place in the engine compartment, so that it is easy to replace the pyrotechnical cartridge.

Instead of the depicted locking and reversing mechanism 19 with the swiveling detent pawls 21, a locking can also occur via a toothed rack and a swiveling detent pawl, such that when the plates 5 and 8 are raised a toothed rack ratchets across the detent pawl, but when it engages with the teeth of the toothed rack a downward movement is prevented. In this case, a predetermined deformation point in the region of this interlocking can take on the function of the shear bolt 25. By activating the detent pawl, i.e., by swiveling this detent pawl, the locking can be abolished and the reversing procedure carried out.

It is also conceivable to combine the plates 5 and 8 into a single mounting plate, to which the seesaw 2 is then linked by means of the bolt 3. The locking and reversing device 19 must then be adapted accordingly.

Instead of the detent pawls 6 and 11, other familiar mechanisms can also be used to hold a pretensioned plate.

In the depicted case, the plate 8 is guided by guide pillars 9, which are arranged inside the compression springs 4.

This allows for a compact construction, which has the advantage that only little installation room is required for the device 100 in the front body. In theory, however, the guides can also be arranged outside of the springs.

Other changes are possible for the practitioner.

In summary, the invented system has the following features and advantages.

A pedestrian protection is described, especially by lifting the engine hood in the rear zone. The necessary raising pathway is achieved with a spring accumulator, taking into account the raising time.

The releasing is done by means of a pyrotechnical actuator, which applies the required force directly via an ejection pin or pushing piston, e.g., a push/pull cable hooked up in between, or a pneumatic or hydraulic control line. But electrical release systems can also be used.

The releasing of the spring accumulator takes place via detent pawls.

In the extended position, the system locks automatically and prevents the engine hood from swinging back, and provides the accident victim an interception of the energy built up in the spring accumulator by shearing or deforming of a deformation element at a predefined force after attaining the elastic deformation of the hood.

The X-displacement of the front hood occurring during the raising is canceled out by a seesaw, without blocking the system.

This enables an adaptation of every possible hinge design.

The reversing, i.e., the resetting of the system is done by a pressing rod and the engine hood. In particular, one makes use of the lever arm of the engine hood to tense the spring accumulator.

This activity can be performed by the driver himself.

1. A device for protecting individuals during a frontal impact with a motor vehicle, which has a front hood, covering the front body and extending up to the front windshield, which is pivoted to the chassis of the front body by a hinge arrangement on both sides of the vehicle at the windshield end, comprising: a hinge beam for indirect linking of the hinge arrangement at the chassis, being arranged so that it can raise up on the chassis of the front body, and an energy accumulating mechanism engaging with the hinge beam in the form of a spring accumulator arrangement, as well as a sensor-controlled holding device for an active engagement with the hinge beam, so that in the normal state the hinge beam is held down and in event of a collision it can be released by sensor activation for a limited raising movement, characterized in that a guiding base plate with double linear guidance is provided in a housing as a mounting plate for the hinge beam, to which the hinge beam is joined off-center by means of a shaft in seesaw fashion, and which actively engages with the spring accumulator arrangement and the sensor-activated holding device.

2. The device according to claim 1, wherein a pretensioning plate is arranged between guiding base plate and spring accumulator arrangement, which is coordinated with another holding device, coupled to the holding device for the guiding base plate, being on the one hand in direct active contact with the springs of the spring accumulator arrangement and on the other hand in direct active contact with the guiding plate.

3. The device according to claim 2, wherein both the guiding base plate and the pretensioning plate are configured as U-shaped profile pieces and both have the profile opening on top, under direct contact of the legs of the profile of the pretensioning plate with the junction yoke of the profile of the guiding base plate, and the profile of the guiding base plate has a bevel for the seesaw motion of the hinge beam when it is raised.

4. The device one of according to claim 1, wherein the spring accumulator arrangement has two compression springs arranged at a distance along the lengthwise dimension of the guiding base plate, which at one end thrust against the bottom of the housing and can be pretensioned at the plate side and also be released by the sensor-controlled holding device.

5. The device according to claim 4, wherein guide pillars guided in guide sleeves fixed to the housing are accommodated inside the compression springs, being screwed together with the guiding base plate at the top end.

6. The device according to 1, wherein the sensor-activated holding device consists of at least one spring-loaded detent pawl for the active engagement at the plate end, having a cam for an active contact with the pin-ejecting pyrotechnical trigger.

7. The device according to claim 1, wherein a mechanism is provided for the deformable locking of the hinge beam in the raised state and for its reversing into the basic state.

8. The device according to claim 7, wherein the mechanism has a U-shaped holder, secured at the plate side, in which two detent pawls can swivel in opposite direction, each possessing a slotted link to accommodate a bolt of a plunger arranged spring-loaded in the holder and a stopping edge for an active locking engagement with a housing edge and a front edge for an active engagement with the bolt in the raised state of the hinge beam.

9. The device according to claim 8, wherein the bolt is designed with a predetermined shearing force or deforming force.

10. The device according to claim 8, wherein the mechanism is configured such that, by applying an external force to the plunger in the raised state of the hinge beam, the detent pawls after eliminating the locking can be swung back with the help of the front hood as a lever arm and the hinge beam can be returned to its basic position against the spring force of the spring accumulator arrangements.

11. The device according to claim 3, wherein the spring accumulator arrangement has two compression springs arranged at a distance along the lengthwise dimension of the guiding base plate, which at one end thrust against the bottom of the housing and can be pretensioned at the plate side and also be released by the sensor-controlled holding device.

12. The device according to claim 11, wherein guide pillars guided in guide sleeves fixed to the housing are accommodated inside the compression springs, being screwed together with the guiding base plate at the top end.

13. The device according to 12, wherein the sensor-activated holding device consists of at least one spring-loaded detent pawl for the active engagement at the plate end, having a cam for an active contact with the pin-ejecting pyrotechnical trigger.

14. The device according to claim 13, wherein a mechanism is provided for the deformable locking of the hinge beam in the raised state and for its reversing into the basic state.

15. The device according to claim 14, wherein the mechanism has a U-shaped holder, secured at the plate side, in which two detent pawls can swivel in opposite direction, each possessing a slotted link to accommodate a bolt of a plunger arranged spring-loaded in the holder and a stopping edge for an active locking engagement with a housing edge and a front edge for an active engagement with the bolt in the raised state of the hinge beam.

16. The device according to claim 15, wherein the bolt is designed with a predetermined shearing force or deforming force.

17. The device according to claim 16, wherein the mechanism is configured such that, by applying an external force to the plunger in the raised state of the hinge beam, the detent pawls after eliminating the locking can be swung back with the help of the front hood as a lever arm and the hinge beam can be returned to its basic position against the spring force of the spring accumulator arrangements
